(19) United States
(12) Patent Application Publication
(10) Pub. No.: US 2020/0134995 A1
(43) Pub. Date: Apr. 30, 2020

(54) HOME DEVICE

(71) Applicant: LG Electronics Inc., Seoul (KR)

(72) Inventors: Inho Lee, Seoul (KR); Junmin Lee, Seoul (KR); Keunsang Lee, Seoul (KR)

(73) Assignee: LG Electronics Inc.

(21) Appl. No.: 16/398,639

(22) Filed: Apr. 30, 2019

(30) Foreign Application Priority Data
Oct. 31, 2018 (KR) 10-2018-0132148

(51) Int. Cl. G08B 13/16; G05D 1/02; G05D 1/00

(52) U.S. Cl. CPC G08B 13/1672; G05D 1/005; G05D 1/0038; G05D 1/0212

(57) ABSTRACT

A home device according to an embodiment of the present invention includes a microphone that collects noise in an outgoing mode of the home device, a communication unit that performs wireless communication with a robot cleaner, and a processor that determines whether the collected noise is abnormal noise, and if the collected noise is determined to be the abnormal noise, transmits a movement command for directing the robot cleaner to move to a place where the home device is positioned, through the communication unit.

### CROSS-REFERENCE TO RELATED APPLICATION

This application claims priority under 35 U.S.C. § 119 to Korean Application No. 10-2018-0132148 filed on Oct. 31, 2018, whose entire disclosure is hereby incorporated by reference.

### BACKGROUND

### 1. Field

The present invention relates to a home device, and more particularly, to a home device capable of detecting abnormal noise by using an artificial intelligence if a user goes out.

### 2. Background

A general unmanned security alarm system is a system that detects an intruder (person or animal), not an internal person, in a house, office or factory, and notifies invasion through a warning light or a warning alarm.

Such an unmanned security alarm system has been developed from a simple system in which a door detection device installed in a doorway detects whether a door is opened or closed and notifies the intrusion into a state-of-the-art vision alarm system in which disadvantages of the simple system are remedied and performance of the system is improved.

In addition, in recent years, it is possible to detect the intrusion (movement) of an outsider through a camera of a movable robot cleaner provided at the house, take a photograph, and then transmit the photographed image to a user.

However, there is a problem that an intruder may not be detected if the intruder enters a place where the robot cleaner is not positioned, since the robot cleaner photographs only the surroundings thereof.

### BRIEF DESCRIPTION OF THE DRAWINGS

The embodiments will be described in detail with reference to the following drawings in which like reference numerals refer to like elements wherein:

FIG. 1 is a diagram for describing a configuration of an intrusion detection system according to an embodiment of the present invention;

FIG. 2 is a block diagram for describing a configuration of a home device according to an embodiment of the present invention;

FIG. 3 is a flowchart for describing an operation method of a home device according to an embodiment of the present invention;

FIG. 4 is a diagram for explaining an example of a sound waveform corresponding to a footstep sound according to an embodiment of the present invention, and FIG. 5 is a diagram for explaining an example of an energy level of a sound waveform corresponding to a footstep sound.

FIG. 6 is a ladder diagram for explaining an operation method of the intrusion detection system according to an embodiment of the present invention; and

FIG. 7 is a diagram for explaining an operation scenario of a home device and a robot cleaner in a situation where an intruder enters a house.]

### DETAILED DESCRIPTION

Hereinafter, exemplary embodiments of the present invention will be described in detail with reference to the accompanying drawings, in which like reference numerals refer to like or similar elements regardless of reference numerals and a duplicated description thereof will be omitted. With respect to constituent elements used in the following description, suffixes “module” and “unit” are given or alternated with each other only in consideration of ease in the preparation of the specification, and do not have or serve as different meanings. In addition, in describing the present invention, if specific description about the prior art related to the present invention may unnecessarily blur the gist of the present invention, detailed description thereof is omitted. In addition, the accompanying drawings have been made only for a better understanding of the embodiments disclosed herein and are not intended to limit technical ideas disclosed herein, and it should be understood that the accompanying drawings are intended to encompass all modifications, equivalents and substitutions included in the spirit and scope of the present invention.

The terms including “first,” “second,” and the like may be used to describe various elements, but the elements are not limited by the terms. The terms, if any, are used for distinguishing between one element and other elements.

It will be understood that if one element is referred to as being “connected to” or “accessed by” another element, one element may be “connected to” or “accessed by” another element via a further element although one element may be directly connected to or directly accessed by another element. On the other hand, it will be understood that if one element is referred to as being “directly connected to” or “directly accessed by” another element, there is no component between the mentioned elements.

The singular forms are intended to include the plural forms as well, unless the context clearly indicates otherwise. The term “comprises” or “has” described herein should be interpreted not to exclude presence or addition possibility of characteristics, numbers, steps, operations, constituent elements, parts or combinations thereof described in the specification but to designate presence of one or more other characteristics, numbers, steps, operations, constituent elements, parts or combinations thereof.

The home device described in this specification may be any one of a cellular phone, a smart phone, a laptop computer, an air conditioner, a refrigerator, a washing machine, a TV, and a styler.

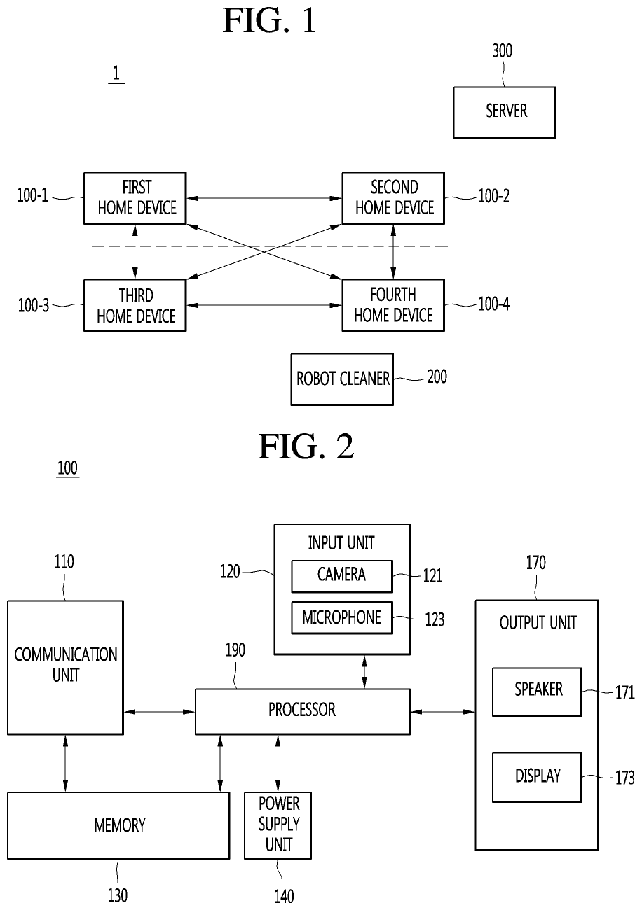

FIG. 1 is a diagram for describing a configuration of an intrusion detection system according to an embodiment of the present invention.

An intrusion detection system 1 according to an embodiment of the present invention may include a plurality of home devices 100-1 to 100-4, a robot cleaner 200, and a server 300.

Each of the plurality of home devices 100-1 to 100-4 is disposed in a house and may be any one of an air conditioner, a refrigerator, a washing machine, a TV, and a styler.

The plurality of home devices 100-1 to 100-4 and the robot cleaner 200 may perform short-range wireless communication with each other. To this end, each of the plurality of home devices 100-1 to 100-4 and the robot cleaner 200 may include a short-range communication module such as a Wi-Fi module or a Bluetooth module.

The plurality of home devices 100-1 to 100-4 and the robot cleaner 200 may perform communication with the server 300.

Each of the plurality of home devices 100-1 to 100-4 may transmit collected noise information to the server 300.

The robot cleaner 200 may receive a command for requesting movement to a specific location in the house from the server 300.

FIG. 2 is a block diagram for describing a configuration of a home device according to an embodiment of the present invention.

Referring to FIG. 2, the home device 100 may include a communication unit 110, an input unit 120, a memory 130, a power supply unit 140, an output unit 170, and a processor 190.

The communication unit 110 may perform wireless communication with other home devices, the robot cleaner 200, or the server 300.

The input unit 120 may include a camera 121 and a microphone 123.

The camera 121 may capture the surroundings of the home device 100.

The microphone 123 may receive ambient noise.

The microphone 123 may receive ambient noise in real time in a user outgoing mode.

The memory 130 may store an image captured by the camera 121 or noise input to the microphone 123.

The power supply unit 140 may supply power to components of the home device 100.

The output unit 170 may include an audio output unit 171 and a display 173.

The audio output unit 171 may output audio.

The display 173 may display an image.

The processor 190 may control the overall operation of the home device 100.

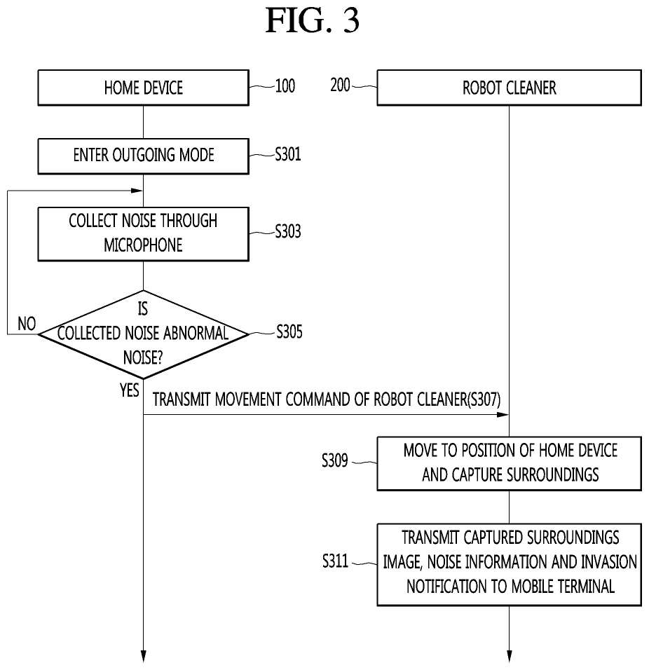

FIG. 3 is a flowchart for describing an operation method of a home device according to an embodiment of the present invention.

Referring to FIG. 3, the processor 190 of the home device 100 may allow an operation mode of the home device 100 to enter an outgoing mode (S301).

In one embodiment, the processor 190 may receive a request for entry into the outgoing mode from the user's mobile terminal (e.g., cellular phone).

In another embodiment, the processor 190 may allow the operation mode of the home device 100 to enter the outgoing mode according to an input of selecting a button provided in the home device 100.

If receiving a request for entry into the outgoing mode from the mobile terminal, any one of the plurality of home devices 100-1 to 100-4 and the robot cleaner 200 provided in the house may transmit the request to the remaining home devices.

Accordingly, if any home device 100 enters the outgoing mode, the remaining home devices may also enter the outgoing mode.

Under the outgoing mode of the home device 100, the processor 190 may collect ambient noise through the microphone 123.

The microphone 123 may receive noise in real time or periodically under the outgoing mode.

The processor 190 may collect noise through the microphone 123 as it enters the outgoing mode (S303). The collected noise may be stored in the memory 130.

The microphone 123 may collect noise at intervals of 10 seconds, which is merely an example.

The processor 190 may determine whether the collected noise is abnormal noise (S305).

In one embodiment, if a pattern of sound waveform corresponding to the noise has a predetermined pattern, the processor 190 may determine that the collected noise is abnormal noise.

Specifically, if a magnitude of the sound waveform corresponding to the collected noise periodically exceeds a reference magnitude, the processor 190 may determine that a corresponding noise is an abnormal noise.

In another embodiment, if an energy level of the sound waveform corresponding to the noise periodically exceeds a reference energy level, the processor 190 may determine the noise to be abnormal noise.

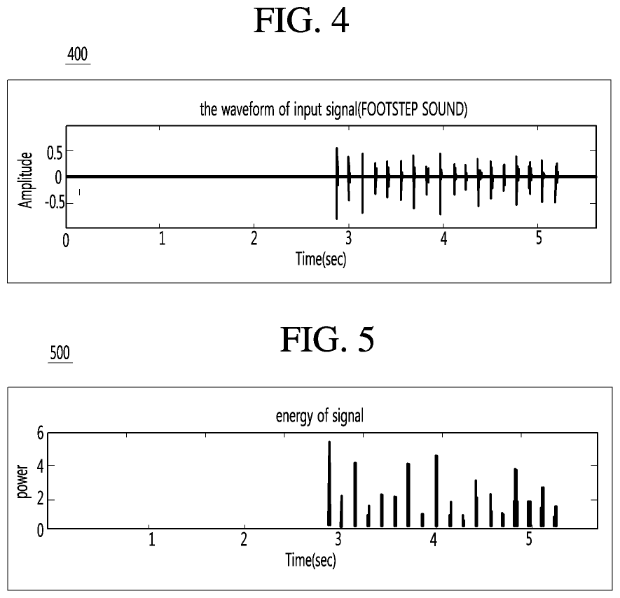

The details will be described with reference to FIGS. 4 and 5.

FIG. 4 is a diagram for explaining an example of a sound waveform corresponding to a footstep sound according to an embodiment of the present invention, and FIG. 5 is a diagram for explaining an example of an energy level of a sound waveform corresponding to a footstep sound.

First, referring to FIG. 4, a sound waveform 400 for a footstep sound is shown. A magnitude of the sound waveform 400 may exceed a reference magnitude (0) periodically or aperiodically.

The processor 190 may determine that the noise is abnormal noise if the magnitude of the sound waveform 400 exceeds the reference magnitude a reference number of times for a predetermined period of time.

If a pattern of the sound waveform 400 is detected as shown in FIG. 4, the processor 400 may determine that the collected noise is abnormal noise.

Next, description will be given with reference to FIG. 5.

Referring to FIG. 5, an energy level 500 corresponding to the sound waveform for footstep sound is shown.

If an energy level exceeds a reference level not less than the reference number of times for a certain period of time, the processor 190 may determine that the noise is abnormal noise.

In another embodiment, if the magnitude of the sound waveform 400 corresponding to the noise exceeds the reference magnitude not less than the reference number of times for the certain period of time and the energy level corresponding to the noise exceeds the reference level not less than the reference number of times for the certain period of time, the processor 190 may determine that the noise is abnormal noise.

Again, description is given with reference to FIG. 3.

If the collected noise is determined to be abnormal noise, the processor 190 may transmit, to the robot cleaner 200, a movement command for directing the robot cleaner 200 to move to a place where the home device 100 is position (S307).

If the collected noise is determined to be abnormal noise, the processor 190 may transmit the movement command to the robot cleaner 200 through the communication unit 110.

The robot cleaner 200 may previously store position information of each of the plurality of home devices 100-1 to 100-4 provided in the house.

In another embodiment, the processor 190 may transmit the position information of the home device 100 to the robot cleaner 200 along with the movement command.

The robot cleaner 200 may control a motor provided therein so as to move to a place where the home device 100 is positioned, according to the movement command received from the home device 100 and after movement, allow a camera provided therein to capture an image of soundings (S309).

The robot cleaner 200 may determine that an intruder has broken into the house according to the movement command and may move to the position of the home device 100 that has transmitted the movement command.

Thereafter, the robot cleaner 200 may capture the surroundings of the home device 100 using the camera provided therein.

The robot cleaner 200 may transmit the captured soundings image, noise information, and an intrusion notification notifying the user that there is the intruder in the house to the user's mobile terminal (not shown) (S311).

The robot cleaner 200 may transmit at least one of an image obtained by capturing the surroundings of the home device 100, noise information inputted through a microphone provided in the robot cleaner 200, and a message informing that there is an intruder in the house, to the user's mobile terminal.

Accordingly, the user may quickly confirm that there is an intruder in his/her house even if he/she goes out.

Also, according to the embodiment of the present invention, it is possible to detect an intruder without having an expensive security system in the house.

In addition, according to the embodiment of the present invention, even if an intruder enters a place where the robot cleaner 200 is not positioned, the intruder may be detected.

Although it is described as an example that the robot cleaner 200 captures the surroundings of the home device 100 and transmits the captured image to the user's mobile terminal, the present invention is not limited thereto.

That is, in step S305, the processor 190 may capture the surroundings of the home device 100 using the camera 121 provided in the home device 100, and transmit the captured image to the user's mobile terminal, if the collected noise is determined to be abnormal noise.

In addition, if the collected noise is determined to be abnormal noise, the processor 190 may transmit an ON command for turning on a camera provided in each of the other home devices to other home devices in addition to its own camera 121.

Each of the other home devices may turn on the camera in response to the received ON command and capture the surroundings thereof. The captured image may be transmitted to the user's mobile terminal.

Accordingly, even if the intruder moves to another home device, the situation of the intruder may be monitored.

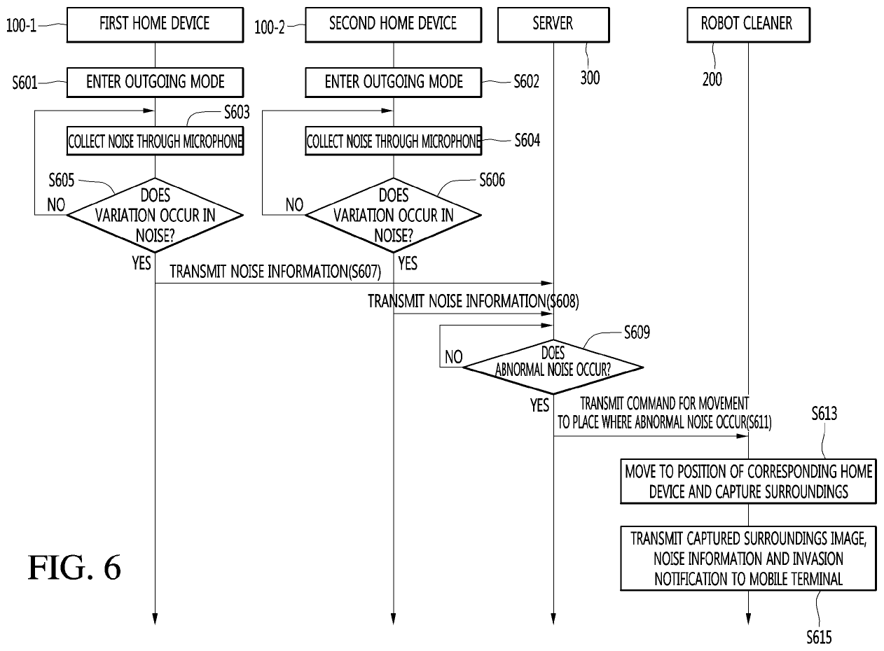

FIG. 6 is a ladder diagram for explaining an operation method of the intrusion detection system according to an embodiment of the present invention.

In particular, FIG. 6 is a diagram of a method of detecting intruders in cooperation with home devices and the server 300.

Referring to FIG. 6, a first home device 100-1 and a second home device 100-2 enter the outgoing mode according to a user's request (S601 and S602).

The first and second home devices 100-1 and 100-2 may collect noise through the microphone 123 as they enter the outgoing mode (S603 and S604).

The first home device 100-1 and the second home device 100-2 may determine whether a variation occurs in the collected noise (S605 and S606).

In one embodiment, each home device may determine that a variation occurs in the noise if the magnitude of the collected noise changes.

The first home device 100-1 and the second home device 100-2 may transmit noise information to the server 300 if the variation occurs in the noise (S607 and S608).

The home device 100 that has detected the variation in noise may transmit the information about the noise to the server 300.

The server 300 may determine whether an abnormal noise occurs, based on pieces of noise information respectively received from the first and second home devices 100-1 and 100-2 (S609).

The process by which the server 300 determines that abnormal noise occurs is referred to the embodiment of FIG. 4 and FIG. 5.

If the abnormal noise occurs, the server 300 may transmit, to the robot cleaner 200, a movement command for instructing the robot cleaner 200 to move to a position of a home device where abnormal noise has occurred (S611).

The server 300 may previously store position information of each of the home devices 100-1 and 100-2 provided in the house.

The position information of the home device 100 may include coordinate information indicating the position of the home device 100 in a house.

The robot cleaner 200 may control a motor provided therein so as to move to a position of the home device 100 where abnormal noise occurs according to the movement command received from the home device 100 and after movement, allow a camera provided therein to capture an image of soundings (S613).

The robot cleaner 200 may transmits the captured soundings image, the sound information, and an intrusion notification notifying the user that there is an intruder in the house to the user's mobile terminal (not shown) (S615).

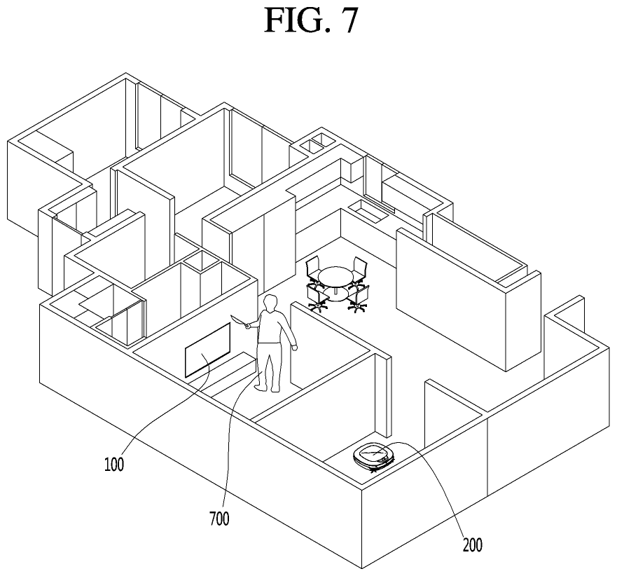

FIG. 7 is a diagram for explaining an operation scenario of a home device and a robot cleaner in a situation where an intruder enters a house.

Referring to FIG. 7, it is assumed that the home device 100 operates in the outgoing mode and an intruder 700 enters a place where the home device 100 is positioned.

The microphone 123 provided in the home device 100 may collect ambient noise.

The home device 100 may transmit a movement command for directing the robot cleaner 200 to move to a place where the home device 100 is positioned if the collected noise is determined to be abnormal noise.

The robot cleaner 200 may move to the place where the home device 100 is positioned and may capture surroundings of the home device 100 in response to the reception of the movement command.

The robot cleaner 200 may transmit the captured image to the user's mobile terminal.

According to the embodiments of the present invention, it is possible to detect an intruder without having a separate expensive security system in the house.

In addition, according to the embodiments of the present invention, it is possible to detect an intruder even if an intruder enters a place where a robot cleaner is not positioned in the house.

The user may quickly confirm whether or not an intruder has broken into the house through the image received through the mobile terminal, and may take measures accordingly.

The present invention described above may be embodied as computer-readable codes on a medium on which a program is recorded. The computer-readable media include all kinds of recording devices in which data readable by a computer system are stored. Examples of the computer readable medium include a hard disk drive (HDD), a solid state disk (SSD), a silicon disk drive (SDD), a ROM, a RAM, a CD-ROM, a magnetic tape, a floppy disk, an optical data storage device, and the like. Also, the computer may include a control unit 180 of the terminal.

Accordingly, the foregoing embodiments are merely exemplary and are not to be considered as limiting the present disclosure. Thus, the scope of the present invention can be determined by rational interpretation of the attached claims and it is intended that the present invention covers the modifications and variations of this invention that come within the scope of the appended claims and their equivalents.

The present invention is directed to solving the above-mentioned problems and other problems.

An object of the present invention is to provide a home device capable of detecting an intruder by using ambient noise input to a microphone provided in a home premises device if the user goes out.

A home device according to an embodiment of the present invention includes a microphone that collects noise in an outgoing mode of the home device, a communication unit that performs wireless communication with a robot cleaner, and a processor that determines whether the collected noise is abnormal noise, and if the collected noise is determined to be the abnormal noise, transmits a movement command for directing the robot cleaner to move to a place where the home device is positioned, through the communication unit.

An intrusion detection system according to an embodiment of the present invention includes a home device that collects noise in a user outgoing mode and if a variation occurs in the collected noise, transmits information about the noise to a server, the server that determines whether the noise received from the home device is abnormal noise, and if the received noise is determined to be the abnormal noise, transmits a movement command for directing the robot cleaner to move to a place where the home device is positioned, and a robot cleaner that moves to a position of the home device according to the movement command received from the server.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A home device comprising:
a microphone configured to receive audio during an outgoing mode of the home device;
a communication device configured to perform wireless communication with a robot cleaner; and
a processor configured to determine whether the received audio is abnormal audio, and when the received audio is determined to be the abnormal audio, transmit, through the communication device, a movement command to direct the robot cleaner to move to a location associated with the home device.

2. The home device of claim 1, wherein the processor is configured to determine that the received audio is the abnormal audio when a sound waveform corresponding to the received audio is determined to have a predetermined pattern.

3. The home device of claim 1, wherein the processor is configured to determine that the received audio is the abnormal audio when a magnitude of a sound waveform corresponding to the received audio is determined to exceed a reference magnitude for at least a predetermined number of times over a predetermined period of time.

4. The home device of claim 1, wherein the processor is configured to determine that the received audio is the abnormal audio when an energy level of the received audio is determined to exceed a reference level for at least a predetermined number of times over a predetermined period of time.

5. The home device of claim 1, wherein the processor is configured to determine that the received audio is the abnormal audio when a magnitude of a sound waveform corresponding to the received audio is determined to exceed a reference magnitude at least a predetermined number of times and an energy level of the audio exceeds a reference level the predetermined number of times over a predetermined period of time.

6. The home device of claim 1, further comprising a camera configured to capture an image,
wherein in response to the processor determining that the received audio is the abnormal audio, the processor is to control the camera to capture an image of surroundings of the home device.

7. The home device of claim 6, wherein the processor to transmit, via the communication device and to the mobile terminal, the captured image of surroundings of the home device.

8. The home device of claim 1, wherein the processor to further transmit, via the communication device, position information of the home device to the robot cleaner when the received audio is determined to be abnormal audio.

9. The home device of claim 1, wherein the processor to transmit, via the communication device, a camera command to at least one electronic apparatus external to the home device, wherein the camera command to turn on a camera at the at least one electronic apparatus.

10. An intrusion detection system comprising:
the home device of claim 1;
another home device;
the robot cleaner; and
a server configured to receive audio information from the home device and the another device, and to provide, to the robot cleaner, a movement command to move the robot cleaner to a location of the home device or the another home device.

11. An intrusion detection system, comprising:
a first home device configured to receive audio during a user outgoing mode, and when a variation is determined to have occurred in the received audio, the first home device is to transmit, to a server, audio information regarding the received audio;
the server configured to determine whether the audio information received from the first home device includes abnormal audio, and when the received audio information is determined to include the abnormal audio, the server is to transmit a first movement command to direct the robot cleaner to move to a first location associated with the first home device; and
a robot cleaner to receive the first movement command from the server, and the robot cleaner is configured to move to the first location of the first home device based on the received first movement command.

12. The intrusion detection system of claim 11, wherein the robot cleaner is to capture an image of surroundings of the first home device and transmit, to a mobile terminal, the captured image and audio information received regarding the first home device.

13. The intrusion detection system of claim 12, wherein the robot cleaner is to further transmit, to the mobile terminal, invasion notification information.

14. The intrusion detection system of claim 11, further comprising a second home device configured to receive additional audio during the user outgoing mode, and when the second home device is to determine that a variation has occurred in the additional audio, the second home device is to transmit, to the server, information regarding the received additional audio.

15. The intrusion detection system of claim 14, wherein when the server determines that the received additional audio includes the abnormal audio, the server is to transmit a second movement command to direct the robot cleaner to move to a second location associated with the second home device, the robot cleaner is to receive the second movement command, and the robot cleaner is configured to move to the second location of the second home device based on the received second movement command.

16. The intrusion detection system of claim 11, wherein the server is to determine that the received audio information includes the abnormal audio when a magnitude of a sound waveform corresponding to the received audio information exceeds a reference magnitude at least a predetermined number of times over a predetermined period of time.

17. The intrusion detection system of claim 11, wherein the server determines that the received audio information includes the abnormal audio when an energy level of the received audio information exceeds a reference level at least a predetermined number of times over a predetermined period of time.

18. A home device comprising:
a microphone configured to receive audio;
a communication device configured to perform wireless communication; and
a processor configured to determine whether the received audio meets a predetermined condition, and when the received audio is determined to meet the predetermined condition, transmit, through the communication device, a movement signal such that a robot cleaner is to move to an area of the home device.

19. The home device of claim 18, further comprising a camera configured to capture an image,
wherein in response to the processor determining that the received audio meets the predetermined condition, the processor is to control the camera to capture an image of surroundings of the home device.

20. The home device of claim 19, wherein the processor to transmit, via the communication device to a mobile terminal, the captured image of surroundings of the home device.
